(19) United States
(12) Patent Application Publication
(10) Pub. No.: US 2025/0270137 A1
(43) Pub. Date: Aug. 28, 2025

(54) NEGATIVE-CARBON CEMENT (NC2) PRODUCTION

(71) Applicant: The Johns Hopkins University., Baltimore, MD (US)

(72) Inventors: Chao WANG, Ellicott, MD (US); Jonah D. ERLEBACHER, Baltimore, MD (US); Yulin LIU, Baltimore, MD (US); Hao SHEN, Baltimore, MD (US)

(21) Appl. No.: 19/077,427

(22) Filed: Mar. 12, 2025

Related U.S. Application Data
(63) Continuation of application No. PCT/US2023/073820, filed on Sep. 11, 2023.
(60) Provisional application No. 63/375,431, filed on Sep. 13, 2022.

(51) Int. Cl. C04B 7/36; B01J 6/00; B01J 8/02; C04B 2/10; C04B 7/34; C04B 11/00; C04B 111/00; C09C 1/48; F27B 15/14

(52) U.S. Cl. CPC C04B 7/367; B01J 6/008; B01J 8/0278; C04B 2/10; C04B 7/34; C04B 11/00; C09C 1/48; F27B 15/14; C04B 2111/00017; F27M 2003/03

(57) ABSTRACT

The present disclosure relates to negative-carbon cement (NC2) production, which can be achieved by integrating carbon dioxide hydrogenation and methane pyrolysis into the cement manufacturing process, using hydrogen gas derived from methane pyrolysis as the fuel for heating, and converting any captured carbon dioxide into solid carbon. The solid carbon can be incorporated into building materials such as portland cement and gypsum boards, fixing the carbon to achieve cradle-to-gate emission reduction.

### CROSS-REFERENCE TO RELATED APPLICATIONS

This application claims the benefit of U.S. Provisional Application No. 63/375,431, filed Sep. 13, 2022, the contents of which are incorporated herein by reference in their entirety.

### FIELD

The present disclosure relates to negative-carbon cement (NC2) production by converting emitted carbon dioxide into solid carbon.

### BACKGROUND

Cement, as the single most widely used material in the world, is the source of about 8% of global carbon dioxide (CO₂) emissions [1]. Approximately 37.9 billion tons of cement was produced worldwide in the past decade, more than half of which was used for building materials [2]. Cement manufacturing emits >3.4 billion tons of CO₂ per year, with ˜85% of this emission coming from the calcination of limestone (CaCO₃) and the fuel combustion reactions used to heat the raw materials (see, e.g., FIG. 1) [3]. Current efforts of emission mitigation in the cement industry focus on the capture of CO₂ from exhaust gas using amine scrubbers or calcium-looping, but such strategies suffer from the high costs associated with compression, storage and transportation (e.g., to sites for sequestration or conversion) of CO₂ gas [4].

### SUMMARY

In one aspect, a process of reducing carbon emissions associated with a cement manufacturing process is described, said method comprising:
calcining a substance comprising calcium carbonate in a first reaction at a calcination temperature to produce calcium oxide and carbon dioxide;
reacting the carbon dioxide from the calcination reaction with reactant hydrogen gas in a second reaction at a hydrogenation temperature to produce methane and water;
pyrolyzing the methane from the hydrogenation reaction in a third reaction at a pyrolysis temperature to produce solid carbon and product hydrogen gas;
reacting at least a portion of the product hydrogen gas with oxygen to produce water and heat, wherein the heat is used to (i) offset the energy needed to pyrolyze the methane in the third reaction, (ii) offset the energy needed to calcinate the calcium carbonate in the first reaction, or (iii) both (i) and (ii); and
directing at least a portion of the product hydrogen gas to the second reaction for use as the reactant hydrogen gas in the hydrogenation reaction.

In another aspect, a system for reducing carbon emissions associated with a cement manufacturing process is described, said system comprising:
a first system for calcining a substance comprising calcium carbonate at a calcination temperature to produce calcium oxide and carbon dioxide;
a second system for reacting the carbon dioxide from the calcination reaction with reactant hydrogen gas at a hydrogenation temperature to produce methane and water;
a third system for pyrolyzing the methane from the hydrogenation reaction at a pyrolysis temperature to produce solid carbon and product hydrogen gas;
at least one additional system for reacting at least a portion of the product hydrogen gas with oxygen to produce water and heat, wherein the heat is used to (i) offset the energy needed to pyrolyze the methane in the third system, (ii) offset the energy needed to calcinate the calcium carbonate in the first system, or (iii) both (i) and (ii); and
means for directing at least a portion of the product hydrogen gas to the second system for use as the reactant hydrogen gas in the hydrogenation reaction.

Other aspects, features and embodiments of the invention will be more fully apparent from the ensuing disclosure and appended claims.

### BRIEF DESCRIPTION OF THE DRAWINGS

FIG. 1 shows the present process of cement production based on fossil fuel combustion.

FIG. 2 illustrates the process of negative-carbon cement (NC2) production. CO₂ emitted from cement manufacturing is captured and converted into carbon, which is incorporated into building materials in solid form. Negative emission is achieved when the produced cement is applied and absorbs CO₂ from air.

FIG. 3 shows the annual CO₂ emission and uptake associated with the production and application of cement materials, respectively. The net emission is also illustrated with the solid black line.

FIG. 4A shows the methane decomposition via the ETCH Process.

FIG. 4B shows that the carbon black derived from methane decomposition via the ETCH Process is generally in the form of hollow carbon particles (˜250 nm in diameter).

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Sorrell, Organic Chemistry, 2^{nd} edition, University Science Books, Sausalito, 2006; Smith, March's Advanced Organic Chemistry: Reactions, Mechanism, and Structure, 7^{th} Edition, John Wiley & Sons, Inc., New York, 2013; Larock, Comprehensive Organic Transformations, 3^{rd} Edition, John Wiley & Sons, Inc., New York, 2018; and Carruthers, Some Modem Methods of Organic Synthesis, 3^{rd} Edition, Cambridge University Press, Cambridge, 1987; the entire contents of each of which are incorporated herein by reference.

“Substantially devoid” is defined herein to mean that none of the indicated substance is intentionally added or present. For example, less than about 1 wt %, preferably less than about 0.1 wt %, and even more preferably less than about 0.01 wt % of the indicated substance is present.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, a “system” refers to a plurality of real and/or abstract elements operating together for a common purpose. In some embodiments, a “system” is an integrated assemblage of hardware and/or software elements. In some embodiments, each component of the system interacts with one or more other elements and/or is related to one or more other elements. In some embodiments, a system refers to a combination of components and software for controlling and directing methods.

As used herein, a “transition metal” includes Ti, V, Cr, Mn, Fe, Co, Ni, Cu, Zr, Nb, Mo, Tc, Ru, Rh, Pd, Ag, Hf, Ta, W, Re, Os, Ir, Pt, and Au. In some embodiments, the transition metals further include Zn, Cd, and Hg. In some embodiments, the transition metals further include the lanthanide and actinide elements.

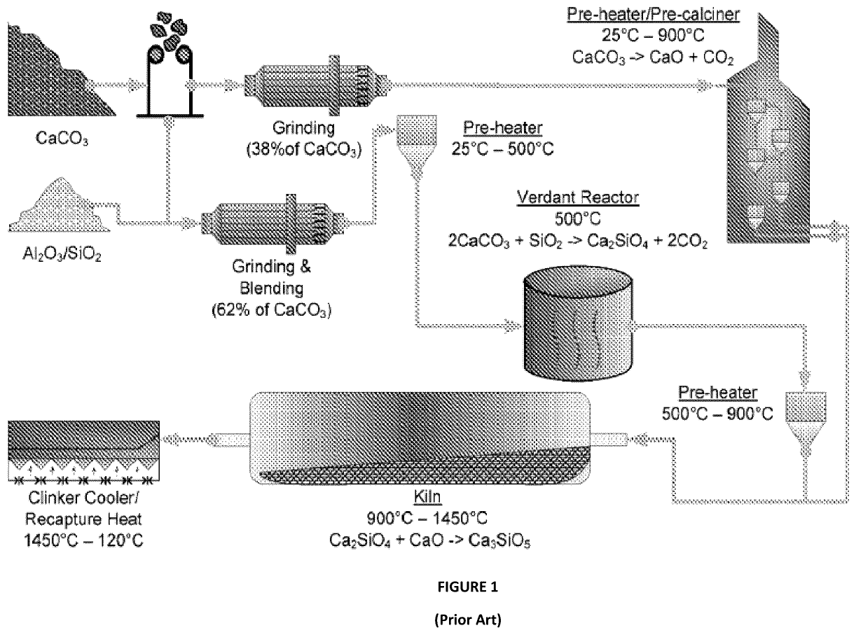

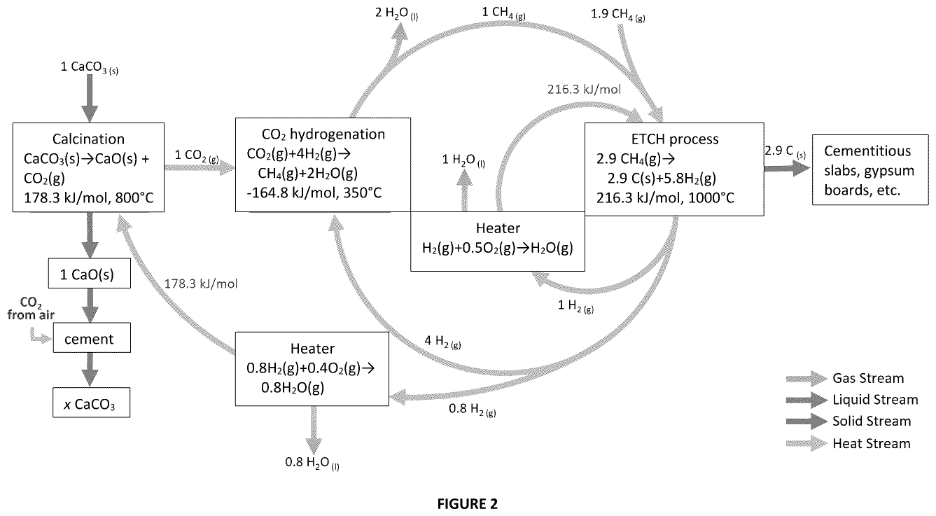

A negative-carbon cement (NC2) production process is disclosed herein, wherein the NC2 process integrates methane pyrolysis into cement manufacture, as shown in FIG. 2. Referring to FIG. 2, the CO₂ emitted from calcination (both CaCO₃ decomposition and/or its reaction with SiO₂, see, e.g., FIG. 1) is converted to CH₄ via hydrogenation. After the removal of water via condensation, this dry CH₄ stream, together with additional natural gas (e.g., methane), is pyrolyzed using a scalable chemical looping method [5](referred to as the ETCH process) to produce solid carbon and hydrogen (H₂). The H₂ produced from this step is used as a fuel to provide heat for both CH₄ pyrolysis and the calcination of CaCO₃, as well as to chemically reduce CO₂ in the hydrogenation reaction (FIG. 2). The overall mass and energy balance of the proposed NC2 process is:

1CaCO₃(s)+1.9CH₄(g)+0.9O₂(g)→1CaO(s)+2.9C(s)+3.8H₂O(l) (1)

It has been reported that the capacity of carbon capture by the carbonation of cement exceeds 109 tons/year [9], which is accomplished via the carbonation reactions [7, 8]:

Ca(OH)₂+CO₂→CaCO₃+H₂O (2)

CaₓSi_{y}O_{x+2y}+xCO₂+zH₂O→xCaCO₃+ySiO₂·zH₂O (3)

Disadvantageously, due to the significant CO₂ emissions associated with the present full cement manufacturing process (e.g., calcination and pyrolysis), the net flux of CO₂ emission is still significantly positive over the lifecycle of cement even with the carbon capture capacity of equations (2) and (3).

In one aspect, the present disclosure relates to a system for reducing carbon emissions associated with a cement manufacturing process, said system comprising:
a first system for calcining a substance comprising calcium carbonate at a calcination temperature to produce calcium oxide and carbon dioxide;
a second system for reacting the carbon dioxide from the calcination reaction with reactant hydrogen gas at a hydrogenation temperature to produce methane and water;
a third system for pyrolyzing the methane from the hydrogenation reaction at a pyrolysis temperature to produce solid carbon and product hydrogen gas;
at least one additional system for reacting at least a portion of the product hydrogen gas with oxygen to produce water and heat, wherein the heat is used to (i) offset the energy needed to pyrolyze the methane in the third system, (ii) offset the energy needed to calcinate the calcium carbonate in the first system, or (iii) both (i) and (ii); and
means for directing at least a portion of the product hydrogen gas to the second system for use as the reactant hydrogen gas in the hydrogenation reaction.

In some embodiments, the system further comprises at least one cement manufacturing apparatus upstream of the first system, wherein the at least one cement manufacturing apparatus produces the calcium carbonate to be calcined.

In another aspect, the present disclosure relates to a process of reducing carbon emissions associated with a cement manufacturing process, said method comprising: calcining a substance comprising calcium carbonate in a first reaction at a calcination temperature to produce calcium oxide and carbon dioxide;
reacting the carbon dioxide from the calcination reaction with reactant hydrogen gas in a second reaction at a hydrogenation temperature to produce methane and water;
pyrolyzing the methane from the hydrogenation reaction in a third reaction at a pyrolysis temperature to produce solid carbon and product hydrogen gas;
reacting at least a portion of the product hydrogen gas with oxygen to produce water and heat, wherein the heat is used to (i) offset the energy needed to pyrolyze the methane in the third reaction, (ii) offset the energy needed to calcinate the calcium carbonate in the first reaction, or (iii) both (i) and (ii); and
directing at least a portion of the product hydrogen gas to the second reaction for use as the reactant hydrogen gas in the hydrogenation reaction.

In some embodiments, the process further comprises at least one cement manufacturing process upstream of the first reaction, wherein the at least one cement manufacturing process produces the calcium carbonate to be calcined.

In some embodiments, the calcination temperature is in a range from about 600° C. to about 1000° C., preferably about 700° C. to about 900° C., more preferably about 750° C. to about 850° C., and most preferably about 800° C. In some embodiments, the calcium oxide produced in the first reaction can be used to produce a cementitious product, for example by reacting the calcium oxide with atmospheric carbon dioxide to produce x CaCO₃, or gypsum. In some embodiments, carbon dioxide from the calcination reaction in the first reaction that is going to be hydrogenated in the second reaction is supplemented with carbon dioxide. In some embodiments, the supplemental carbon dioxide is produced when calcium carbonate and silicon dioxide are reacted (e.g., in the Verdant reactor in FIG. 1). In some embodiments, the supplemental carbon dioxide is provided from some other source. In some embodiments, the CO₂ hydrogenation temperature is in a range from about 200° C. to about 500° C., preferably about 300° C. to about 400° C., and more preferably about 350° C. In some embodiments, the CO₂ hydrogenation reaction occurs in the presence of at least one hydrogenation catalyst. In some embodiments, the CO₂ hydrogenation reaction occurs at atmospheric pressure. In some embodiments, additional methane is introduced into the third reaction to produce enough product hydrogen gas for the reaction with oxygen to produce heat and/or introduction of the product hydrogen gas to the second reaction for use as the reactant hydrogen gas in the hydrogenation reaction. In some embodiments, the pyrolysis reaction (i.e., ETCH process) occurs in the presence of at least one pyrolysis catalyst. In some embodiments, the pyrolysis reaction occurs in the presence of at least one pyrolysis catalyst, via thermal or plasma decomposition. In some embodiments, at least a portion of the reactant hydrogen gas comes from a source other than the processes described herein. In some embodiments, at least a portion of the energy needed to (i) pyrolyze the methane in the third reaction, (ii) calcinate the calcium carbonate in the first reaction, or (iii) both (i) and (ii), comes from a source other than the processes described herein. In some embodiments, the reaction of at least a portion of the product hydrogen gas with oxygen to produce water and heat can occur in a fourth reaction, wherein the heat is divided for direction to the first reaction and the third reaction. In some embodiments, the reaction of at least a portion of the product hydrogen gas with oxygen to produce water and heat can occur in a fourth reaction and a fifth reaction, wherein the heat from the fourth reaction is directed to the first reaction and the heat from the fifth reaction is directed to the third reaction. In some embodiments, the solid carbon is the form of hollow microparticles approximately 100 nm to about 400 nm in diameter. In some embodiments, the carbon emissions associated with the process are reduced such that the overall process has a net negative carbon emission.

It should be appreciated by the person skilled in the art that the individual reactions take place in apparatuses/devices/systems chosen based on the requirements of the reactions taking place within said apparatuses/devices/systems (e.g., temperature, nature of the reactants and products, pH, pressure, etc.). It should be appreciated that the apparatuses/devices/systems used can be the same as or different from one another, as readily determined by the person skilled in the art.

In some embodiments, the CO₂ hydrogenation reaction occurs in the presence of at least one hydrogenation catalyst, wherein the hydrogenation catalyst is based on oxide-supported transition metals to improve the efficiency of CO₂ to methane conversion. For example, a fixed-bed reactor and Ni/Al₂O₃ hydrogenation catalysts can be used and 80% CO₂ conversion and 100% CH₄ selectivity can be achieved at 350° C. and atmospheric pressure [10]. In some embodiments, at least one hydrogenation catalyst is designed, synthesized and/or characterized to have different transition metal compositions (e.g., by alloying) and particle sizes. Reaction parameters (temperature, pressure, gas flow rates, etc.) can also be optimized to accelerate the kinetics and maximize the rate of reaction.

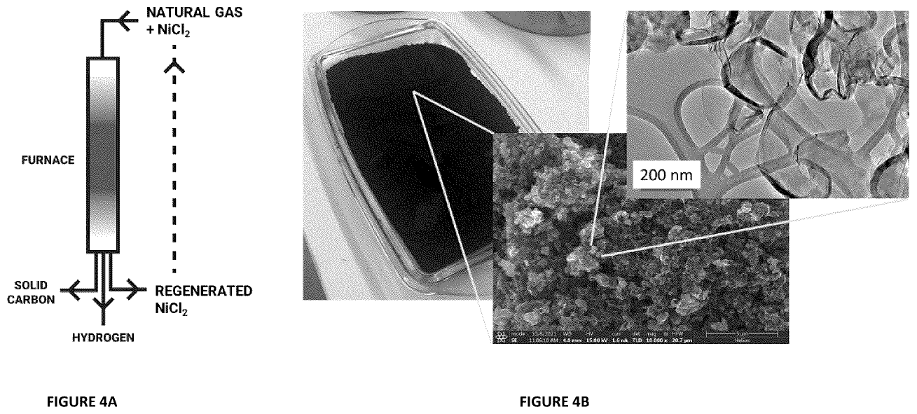

In one embodiment, the pyrolysis cycle (also called the ETCH process) to produce hydrogen and carbon is as follows. Referring to FIG. 4A, a reactant stream of at least one hydrocarbon (i.e., “Natural gas” in FIG. 4A) is introduced into a reaction containing a pyrolysis catalyst, e.g., anhydrous nickel chloride (NiCl₂). In some embodiments, the reaction is substantially devoid of oxygen and water. In some embodiments, the at least one hydrocarbon comprises methane. In some embodiments, at least a portion, or all, of the methane comprises methane obtained from the CO₂ hydrogenation reaction. In one embodiment, a metal halide pyrolysis catalyst, e.g., a metal chloride such as nickel chloride, is chosen to react with the at least one hydrocarbon (e.g., methane), because the temperature at which the reaction proceeds is between 500 and 1000° C. The methane and NiCl₂ pyrolysis catalyst react as follows:

CH₄+2NiCl₂→2Ni+C+4HCl (4)

In some embodiments, any anhydrous metal halide salt can be used as a pyrolysis catalyst in reaction (4), as long as more than one hydrogen halide molecule is produced per molecule of hydrocarbon molecule input. In some embodiments, instead of a metal chloride, the pyrolysis catalyst comprises a metal fluoride, a metal bromide, or a metal iodide. The metal halide pyrolysis catalyst can comprise metals such as Ni, Fe, Co, Mn, Cu, Zn, Ca, and Mg. Advantageously, after the pyrolysis reaction, the anhydrous metal halide salt catalyst (e.g., nickel), carbon, and hydrogen chloride gas are cooled to temperatures below approximately 550° C. Below this temperature, the metal, e.g., nickel, spontaneously reacts with HCl according to the chemical reaction of formula (5):

2Ni+4HCl→2NiCl₂+2H₂ (5)

The hydrogen gas can be separated from the other species present in the reaction system. In some embodiments, the carbon can be separated from the anhydrous metal halide salt catalyst, e.g., NiCl₂, by subliming the anhydrous metal halide salt catalyst at about 10000 and condensing it away from the carbon, which can then be physically removed from the system. Other methods of separation will be known to those familiar with the art of chemical separations. Notably, if the at least one hydrocarbon comprises hydrocarbons containing one or more C—C bonds, pyrolysis catalysts suitable for cracking alkanes, such as the zeolite HZSM-5 may be required. In some embodiments, very high temperatures can be used to produce hydrogen from methane, wherein no pyrolysis catalyst is used. Other processes where methane is decomposed into hydrogen and solid carbon are contemplated herein, as readily understood by the person skilled in the art.

Notably, any anhydrous metal halide salt can be used as a pyrolysis catalyst in reaction (4), as long as more than one hydrogen halide molecule is produced per molecule of hydrocarbon molecule input. In some embodiments, instead of a metal chloride, the pyrolysis catalyst comprises a metal fluoride, a metal bromide, or a metal iodide. The metal halide pyrolysis catalyst can comprise metals such as Ni, Fe, Co, Mn, Cu, Zn, Ca, and Mg.

In some embodiments, the carbon derived from the pyrolysis step (i.e., the ETCH process) is typically in the form of hollow microparticles approximately 250 nm in diameter (see, FIG. 4B). In some embodiments, the carbon is highly pure; chlorocarbons or leachable aromatics are not detectable, and the metal content is <300 ppb per the standard Toxicity Characteristic Leaching Procedure (TCLP). The carbon is lightweight, has equal or improved thermal and fire performance relevant to currently used materials, and potentially better resistance to moisture and humidity. Moreover, the hollow graphitic particles are not the same material as carbon black, which is a form of paracrystalline carbon. Because of the significantly larger size of the carbon comprising hollow graphitic particles, it is less prone to static charging and has excellent flowability and other rheological properties. As such, the carbon derived from the pyrolysis step (i.e., the ETCH Process) can be incorporated into building materials such as concrete (Portland cement), gypsum (calcined calcium sulfate), cementitious boards and pre-cast, post-tensioned, components.

In some embodiments, the pyrolysis reaction conditions are tuned to produce solid carbon having other form factors such as nanofibers.

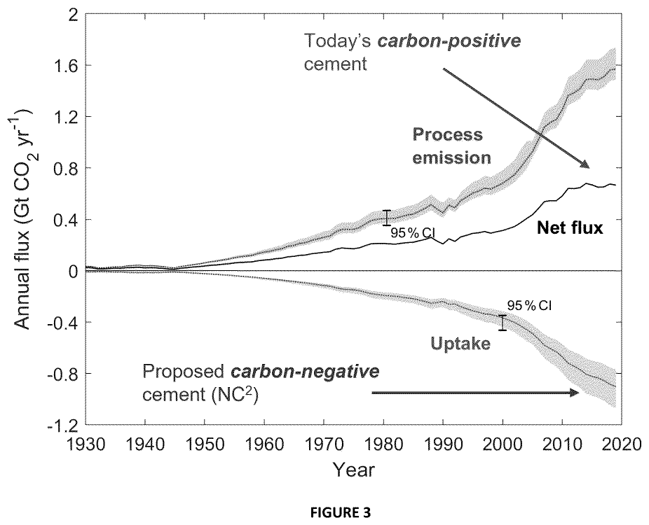

Advantageously, the NC2 process disclosed herein is able to achieve a net negative emission on the gigatonne-per-year scale (see, FIG. 3). This net negative emission is achieved, in part, by burning the H₂ produced in the pyrolysis reaction and providing the energy from the water condensation reactions to the calcination and the pyrolysis reactions, as depicted in FIG. 2.

Further, the NC2 process substantially reduces carbon emissions. All elemental carbon present at the calcination stage is converted into solid carbon using the processes described herein. By burning H₂ to provide energy to the calcination and pyrolysis reactions, carbon emissions produced by outside fuel combustion (e.g., coal, CH₄, etc.) to heat these reactions are eliminated or substantially reduced. Moreover, the temperature of an H₂ flame is as high as 2000° C., much higher than that of a coal (750-1200° C.) or a CH₄ flame (900-1500° C.) presently used in cement kilns, which may improve the energy efficiency and product quality [6]. In addition, the CO₂ emission from calcination is efficiently and cost-effectively converted to solid carbon in the overall NC2 process. The overall NC2 process can thus be substantially powered by hydrogen gas and produce carbon almost exclusively in solid form.

It is understood that the foregoing detailed description and accompanying examples are merely illustrative and are not to be taken as limitations upon the scope of the disclosure, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the disclosure, may be made without departing from the spirit and scope thereof.

### REFERENCES

[1] J. Lehne, F. Preston, Making Concrete Change. Innovation in Low-Carbon Cement and Concrete, CHATHAM HOUSE REPORT 2018.
[2] Mineral commodity summaries, U.S. Geological Survey, Reston, V A, 2021.
[3] M. S. Imbabi, C. Carrigan, S. McKenna, Trends and developments in green cement and concrete technology, Inter. J. Sustain. Built Environ. 2012, 1, 194-216.
[4] L. M. Romeo, D. Catalina, P. Lisbona, Y. Lara, A. Martinez, Reduction of greenhouse gas emissions by integration of cement plants, power plants, and CO₂ capture systems, Greenh Gases 2011, 1, 72-82.
[5] U.S. Pat. No. 9,776,860, 2017.
[6] K. Kuparinen, E. Vakkilainen, Green Pulp Mill: Renewable Alternatives to Fossil Fuels in Lime Kiln Operations, Bioresources 2017, 12, 4031-4048.
[7] E. Possan, W. A. Thomaz, G. A. Aleandri, E. F. Felix, A. C. P. dos Santos, CO₂ uptake potential due to concrete carbonation: A case study, Case Studies in Construction Materials 2017, 6, 147-161.
[8] R. Guo, J. Wang, L. Bing, D. Tong, P. Ciais, S. J. Davis, R. M. Andrew, F. Xi, Z. Liu, Global CO₂ uptake by cement from 1930 to 2019, Earth System Science Data 2021, 13, 1791-1805.
[9] F. Xi et al., Substantial global carbon uptake by cement carbonation, Nat Geosci 2016, 9, 880-883.
[10] H. Muroyama, Y. Tsuda, H. Masitah, T. Okanishi, T. Matsui, K. Eguchi, Carbon dioxide methantion over Ni catalysts supported on various metal oxides, J Catal 2016, 343, 178-184.

1. A process of reducing carbon emissions associated with a cement manufacturing process, said method comprising:
calcining a substance comprising calcium carbonate in a first reaction at a calcination temperature to produce calcium oxide and carbon dioxide;
reacting the carbon dioxide from the calcination reaction with reactant hydrogen gas in a second reaction at a hydrogenation temperature to produce methane and water;
pyrolyzing the methane from the hydrogenation reaction in a third reaction at a pyrolysis temperature to produce solid carbon and product hydrogen gas;
reacting at least a portion of the product hydrogen gas with oxygen to produce water and heat, wherein the heat is used to (i) offset the energy needed to pyrolyze the methane in the third reaction, (ii) offset the energy needed to calcinate the calcium carbonate in the first reaction, or (iii) both (i) and (ii); and
directing at least a portion of the product hydrogen gas to the second reaction for use as the reactant hydrogen gas in the hydrogenation reaction.

2. The process of claim 1, wherein the calcination temperature is in a range from about 600° C. to about 1000° C.

3. The process of claim 1, wherein the calcium oxide produced in the first reaction is used to produce a cementitious product or gypsum.

4. The process of claim 1, wherein the hydrogenation temperature is in a range from about 200° C. to about 500° C.

5. The process of claim 1, wherein the hydrogenation reaction occurs in the presence of at least one hydrogenation catalyst.

6. The process of claim 5, wherein the at least one hydrogenation catalyst comprises an oxide-supported transition metal.

7. The process of claim 1, wherein additional methane is introduced to the third reaction to produce additional product hydrogen gas.

8. The process of claim 1, wherein the pyrolysis reaction occurs in the presence of at least one pyrolysis catalyst, via thermal or plasma decomposition, or any other means that decomposes methane into hydrogen and solid carbon.

9. The process of claim 8, wherein at least one reactant in the pyrolysis reaction comprises a metal halide species, wherein the metal is selected from the group consisting of Ni, Fe, Co, Mn, Cu, Zn, Ca, and Mg, and the halide is selected from the group consisting of fluoride, chloride, bromide, and iodide.

10. The process of claim 1, wherein carbon emissions associated with the process are reduced such that the process has a net negative carbon emission.

11. A system for reducing carbon emissions associated with a cement manufacturing process, said system comprising:
a first system for calcining a substance comprising calcium carbonate at a calcination temperature to produce calcium oxide and carbon dioxide;
a second system for reacting the carbon dioxide from the calcination reaction with reactant hydrogen gas at a hydrogenation temperature to produce methane and water;
a third system for pyrolyzing the methane from the hydrogenation reaction at a pyrolysis temperature to produce solid carbon and product hydrogen gas;
at least one additional system for reacting at least a portion of the product hydrogen gas with oxygen to produce water and heat, wherein the heat is used to (i) offset the energy needed to pyrolyze the methane in the third system, (ii) offset the energy needed to calcinate the calcium carbonate in the first system, or (iii) both (i) and (ii); and
means for directing at least a portion of the product hydrogen gas to the second system for use as the reactant hydrogen gas in the hydrogenation reaction.

12. The system of claim 11, wherein the calcination temperature is in a range from about 600° C.

13. The system of claim 11, wherein the calcium oxide produced in the first system is used to produce a cementitious product or gypsum.

14. The system of claim 11, wherein the hydrogenation temperature is in a range from about 200° C. to about 500° C.

15. The system of claim 11, wherein the hydrogenation reaction occurs in the presence of at least one hydrogenation catalyst.

16. The system of claim 15, wherein the at least one hydrogenation catalyst comprises an oxide-supported transition metal.

17. The system of claim 11, wherein additional methane is introduced to the third system to produce additional product hydrogen gas.

18. The system of claim 11, wherein the pyrolysis reaction occurs in the presence of at least one pyrolysis catalyst, via thermal or plasma decomposition, or any other means that decomposes methane into hydrogen and solid carbon.

19. The system of claim 18, wherein at least one reactant in the pyrolysis reaction comprises a metal halide species, wherein the metal is selected from the group consisting of Ni, Fe, Co, Mn, Cu, Zn, Ca, and Mg, and the halide is selected from the group consisting of fluoride, chloride, bromide, and iodide.

20. The system of claim 11, wherein carbon emissions associated with the system are reduced such that the system has a net negative carbon emission.
